(19) United States
(12) Patent Application Publication
(10) Pub. No.: US 2012/0320602 A1
(43) Pub. Date: Dec. 20, 2012

(54) ENGAGEABLE LED OPTICS AND LIGHTING FIXTURES INCORPORATING THEM

(76) Inventor: Scott Riesebosch, St. Catharines (CA)

(21) Appl. No.: 13/159,859

(22) Filed: Jun. 14, 2011

(51) Int. Cl. F21V 7/04

(52) U.S. Cl. 362/297; 362/307

(57) ABSTRACT

Total internal reflection (TIR) optics have an engagement member that mates with a complementary feature on the LED holder. The engagement member does not interfere with light propagation through or emission from the optical component, and does not enlarge the footprint area occupied by the optical component.

### FIELD OF THE INVENTION

The present invention generally relates to lighting systems, and more specifically to lighting systems using light-emitting diodes whose outputs are directed by optical elements.

### BACKGROUND

Discrete light sources such as light-emitting diodes (LEDs) are an attractive alternative to incandescent light bulbs in illumination devices due to their smaller form factor, longer lifetime, and enhanced mechanical robustness. For a wide variety of lighting applications, the light from one or more LEDs is frequently diffused and directed by optical elements such as total-internal-reflection (TIR) optics. Thus, even though LEDs are effectively omnidirectional point sources of light, the light from LEDs may propagate through a large area and/or in specific directions.

Traditionally, optical engineers have designed lenses to obtain a desired illumination pattern from an LED or LED system. Lenses, however, can only collect light within their diameters; light outside the diameter of lens is lost, resulting in the need for further optics to capture such light. TIR optics utilize the principle of total internal reflection—whereby light is reflected at the boundary (or boundaries) of the optic and retained therein—and typically encompass the entire light source, thereby reducing or eliminating optical loss.

Multi-LED lamps may include a lens assembly including an arrangement of TIR optics and an LED holder to which the lens assembly attaches. The LED holder physically supports and supplies power to the LEDs. It may also act as (or contain) a heat sink that conducts heat away from the LEDs. The lenses are made of a translucent or transparent TIR material for focusing light from associated of LEDs. TIR ensures that light is directed only to the output face of the optic, and is not lost through the sidewalls.

Existing ways of mechanically fastening the lenses to the LED holder include the use of mounting posts (which affix the lenses to matching holes in the LED holder), “snap” fasteners on the LED holder that engage the lens assembly, and retaining rings. Each of these approaches has drawbacks. Because they occupy space on the LED holder, mounting posts restrict the size of the TIR optics. A grouping of post-mounted TIR lenses must leave room for the posts, and as a result, the lenses cannot be “close-packed” adjacently so as to exploit all available room on the holder.

Snap fasteners that reach around to the front of the lens assembly block a portion of the emitted light, and even if they only engage the sidewall rather than the emitting surface of the lens—or are built into the sidewall—they still occupy space and can reduce the TIR optic's beam output because the sidewall is not smooth. Retaining rings typically also block some of the output light.

### SUMMARY

In accordance with certain embodiments, the TIR optics themselves have an engagement member that mates with a complementary feature on the LED holder. The engagement member does not interfere with light propagation through or emission from the optical component. Also, it does not enlarge the footprint area occupied by the optical component.

In an aspect, embodiments of the invention feature a TIR optical component comprising a transparent or translucent body that itself comprises at least one sidewall defining a side portion of the body; a top surface for emitting light; a bottom portion opposed to the top portion and including a bottom surface, where bottom portion is configured to receive light from an LED; and an engagement member on the bottom surface for mating with a complementary feature on an LED holder. Light entering the bottom portion is emitted from the top surface substantially without losses through the at least one sidewall. The engagement member does not interfere with light propagation through or emission from the optical component and does not enlarge a footprint area of the optical component.

The bottom surface may or may not be substantially planar, and may surround a cavity for receiving an LED. The sidewall(s) may be a single angled sidewall such that the optical component has a frusto-conical configuration. In various embodiments, the engagement member is at least one tab, at least one hooked catch, at least one recess for receiving a tab, and/or a continuous or discontinuous rib projecting from the bottom surface and recessed from the sidewall.

In another aspect, the invention relates to a lamp assembly comprising a holder for a plurality of LEDs and, mounted on the holder, a plurality of TIR optical components each comprising a transparent or translucent body. The body of each TIR component comprises at least one sidewall defining a side portion of the body; a top surface for emitting light; a bottom portion opposed to the top portion and including a bottom surface, where the bottom portion is configured to receive light from an LED on the holder; and an engagement member on the bottom surface for mating with a complementary feature on the holder. Light entering the bottom portion is emitted from the top surface substantially without losses through the at least one sidewall. The engagement member does not interfere with light propagation through or emission from the optical component and does not enlarge a footprint area of the optical component. The LED holder is configured to support an LED below each of the TIR optical components.

In some embodiments, the TIR optical components are arranged in a close-packed configuration on the LED holder whereby each of the TIR optical components is in contact with at least one (and in some implementations at least three) neighboring TIR optical components. Mating of the engagement members and the complementary features may fixedly retain the TIR optical components on the LED holder, or instead may orient the TIR optical components on the LED holder; in the latter case, the TIR optical components may be fixedly retained on the LED holder by an adhesive, for example. In various embodiments, the bottom surface of each of the TIR optical components surrounds a recess for receiving an LED, and the LED holder is configured such that each supported LED enters the recess of an associated TIR optical component.

Each TIR optical component may have a single angled sidewall so as to exhibit a frusto-conical configuration. The engagement member of each TIR optical component may be at least one tab, at least one hooked catch, at least one recess for receiving a tab, and/or a continuous or discontinuous rib projecting from the bottom surface and recessed from the sidewall. The TIR optical components may be elements of a single lens array or fixture.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means ±10%, and in some embodiments, ±5%.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIGS. 1A-1D are elevational sections of TIR optics in accordance with the present invention.

FIG. 2 is a plan view of an LED holder to which the TIR optics may be mounted.

FIG. 3 is a side view of the LED holder illustrated in FIG. 2.

FIG. 4 is a plan view of an LED holder with the TIR optics mounted in place.

### DETAILED DESCRIPTION

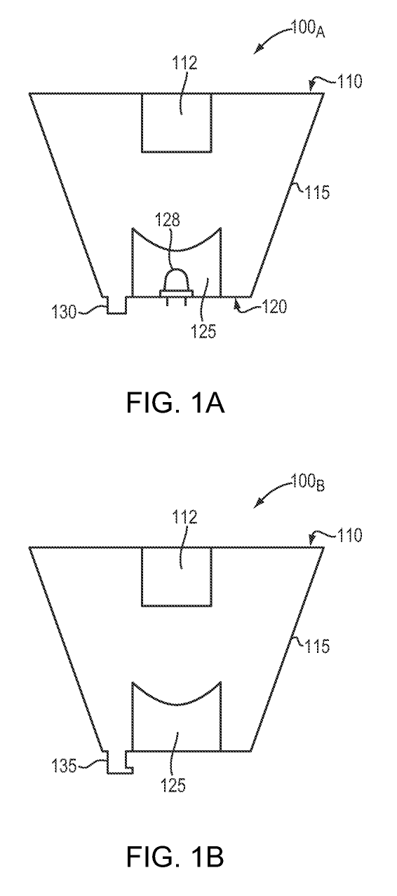

Refer first to FIGS. 1A-1D, which illustrate various implementations of TIR optical components in accordance with the invention. In FIG. 1A, a TIR optical component 100_{A} has a top emission surface 110 that includes a depression 112; a single, continuous, angled sidewall 115; and a bottom surface 120, which may or may not be substantially planar. Because sidewall 115 is angled, the overall area footprint of TIR component 100_{A} corresponds to the area of the top emission surface 110 (i.e., the widest region of the component).

A cavity 125, which extends into the component 100_{A} from the bottom surface 120, receives a discrete light source (typically, and interchangeably referred to herein as, an LED) 128 and traps light emitted therefrom. LED 128 is typically a packaged LED that includes the LED chip, associated electronics, and a package featuring a lens surrounding the chip. LED 128 is positioned such that substantially all of the light that it emits propagates into optic 100_{A} and is confined therein until emerging out its top emission surface 110. The unoccupied space in cavity 125 may, in some embodiments, be filled with an optically compatible material having a refractive index similar or identical to that of component 100_{A}.

The surface to which the component 100_{A} is mounted may be reflective to prevent loss of light through the surface 120. In the illustrated embodiment, surface 120 is an annular ring surrounding cavity 125, but in other embodiments, the surface 120 may extend over the entirety of the bottom portion of component 100_{A} with light coupled into the component by means other than a cavity.

One or more engagement members—in FIG. 1A, one or more tabs 130—depend from the surface 120. By “tab” is meant any protrusion capable of engaging (i.e., fitting snugly within) a complementary recess. A tab may have straight or rounded sides, e.g., it may take the form of a square projection, a rounded bump, or a short post. The tab(s) 130 may be recessed from the sidewall 115 so as not to interfere with propagation of light within the component 100_{A}. As a result, a portion of the bottom surface 120 forms a shoulder against each tab 130, and because of the recession, the tab(s) 130 do not add to the footprint of the TIR component 100_{A}. Again, there may be a single tab 130 or a plurality of tabs; indeed, a series of tabs 130 may form a castellated structure along surface 120, with the tabs acting as teeth to engage complementary recesses as described below.

Numerous variations are possible. In part, the engagement member optimal for a particular TIR optic may depend on whether the feature is used merely to orient the optic or to secure it to the LED holder. As shown in FIGS. 1B-1D, the engagement member of a TIR component may be one or more (typically a plurality) of hooked catches 135 (FIG. 1B, TIR component 100_{B}); a recess 140 rather than a protrusion (FIG. 1C, TIR component 100_{C}); or a continuous (or discontinuous) rib 145 (FIG. 1D, TIR component 100_{D}). Hooked catches 135 are generally better suited to retention than are tabs or a rib, but a slight radial mismatch between the positions of engagement members and their complements on the LED holder can create a compression fit that promotes retention.

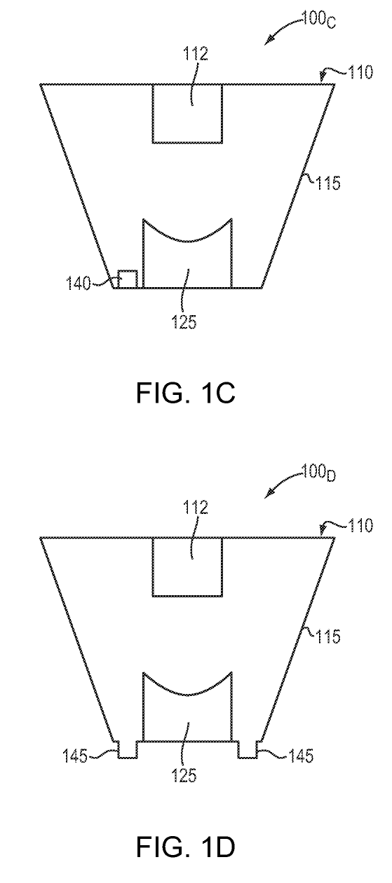

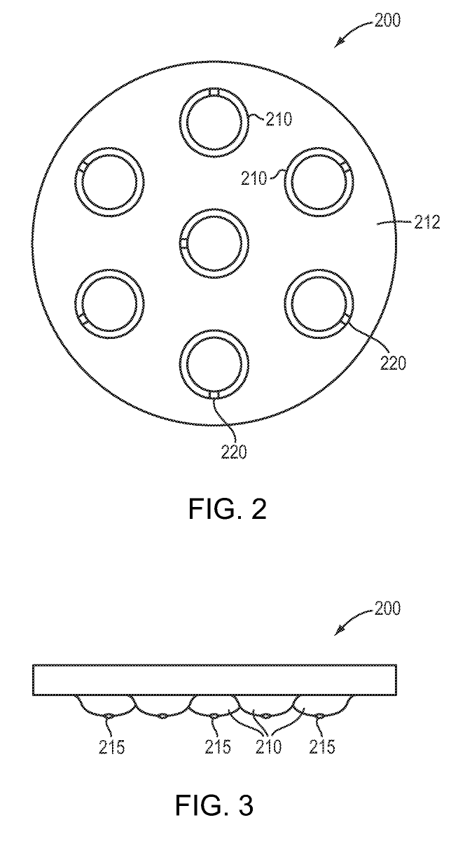

FIGS. 2 and 3 depict an LED holder 200 for supporting and powering an arrangement of LEDs, each of which is retained within one of the wells 210. The wells 210 are depressions within a base 212. In some embodiments, the wells contain the LED mounted on a small printed circuit board (PCB) with various associated electronic components (e.g., for power conditioning), and the exterior surface of each well 210 has a terminal or contact 215 that electrically engages (by simple contact or by soldering) a power supply (not shown). Alternatively, all of the power-conditioning and control circuitry may be external to the well 210, residing, for example, in a central controller.

Each of the wells 210 has along its edge at least one complementary engagement feature 220 for mating with the engagement member of the TIR optic. In FIG. 2, a single, square recess 220 mates with the tab 130 shown in FIG. 1A, but as noted previously, there may be any number of tabs 130 and complementary recesses 220 surrounding each well 210. A single tab and recess may be preferred if the purpose is alignment and orientation, in which case the TIR component may be secured to the base 212 by adhesive.

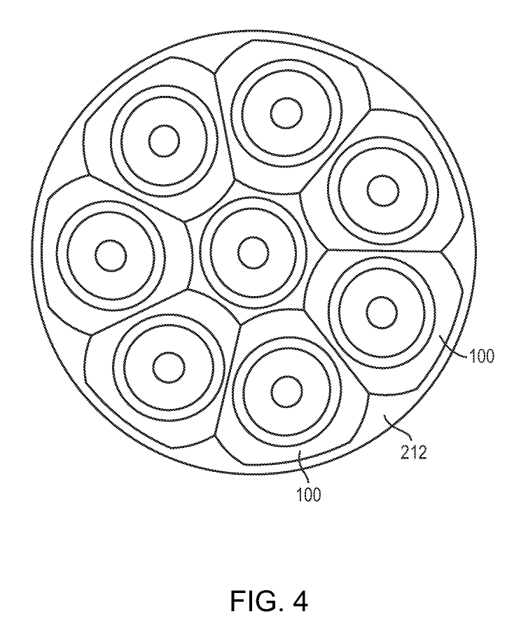

With reference to FIG. 4, because the engagement members do not affect the footprint of the TIR components, those components may be “close packed” in a configuration that leaves essentially no space between them (i.e., between their emission surfaces). In the illustrated embodiment, each TIR component makes contact with at least three neighbors, although in various embodiments, each TIR component may make contact with fewer (e.g., one or two) neighbors. The TIR components may be separate or can be molded into a single multi-optic fixture having an envelope boundary substantially congruent with the boundary of the LED holder 200. In this way, all of the engagement members can be mated with their complementary features in a single assembly step.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A total internal reflection (TIR) optical component comprising a transparent or translucent body that itself comprises:
at least one sidewall defining a side portion of the body;
a top surface for emitting light;
a bottom portion opposed to the top portion and including a bottom surface, the bottom portion being configured to receive light from a light-emitting diode (LED); and
an engagement member on the bottom surface for mating with a complementary feature on an LED holder,
wherein light entering the bottom portion is emitted from the top surface substantially without losses through the at least one sidewall, and further wherein the engagement member (i) does not interfere with light propagation through or emission from the optical component and (ii) does not enlarge a footprint area of the optical component.

2. The optical component of claim 1 wherein the bottom surface surrounds a cavity for receiving an LED.

3. The optical component of claim 1 wherein the at least one sidewall is a single angled sidewall such that the optical component has a frusto-conical configuration.

4. The optical component of claim 1 wherein the engagement member is at least one tab.

5. The optical component of claim 1 wherein the engagement member is at least one hooked catch.

6. The optical component of claim 1 wherein the engagement member is at least one recess for receiving a tab.

7. The optical component of claim 1 wherein the engagement member is a rib projecting from the bottom surface and recessed from the sidewall.

8. A lamp assembly comprising a holder for a plurality of light-emitting diodes (LEDs) and, mounted on the holder, a plurality of total internal reflection (TIR) optical components each comprising a transparent or translucent body that itself comprises:
at least one sidewall defining a side portion of the body;
a top surface for emitting light;
a bottom portion opposed to the top portion and including a bottom surface, the bottom portion being configured to receive light from an LED on the holder; and
an engagement member on the bottom surface for mating with a complementary feature on the holder, wherein light entering the bottom portion is emitted from the top surface substantially without losses through the at least one sidewall, and further wherein the engagement member (i) does not interfere with light propagation through or emission from the optical component and (ii) does not enlarge a footprint area of the optical component, the LED holder being configured to support an LED below each of the TIR optical components.

9. The lamp assembly of claim 8 wherein the TIR optical components are arranged in a close-packed configuration on the LED holder whereby each of the TIR optical components is in contact with at least one neighboring TIR optical component.

10. The lamp assembly of claim 8 wherein mating of the engagement members and the complementary features fixedly retains the TIR optical components on the LED holder.

11. The lamp assembly of claim 8 wherein mating of the engagement members and the complementary features orients the TIR optical components on the LED holder, the TIR optical components being fixedly retained on the LED holder by an adhesive.

12. The lamp assembly of claim 8 wherein the bottom surface of each of the TIR optical components surrounds a recess for receiving an LED, the LED holder being configured such that each supported LED enters the recess of an associated TIR optical component.

13. The lamp assembly of claim 8 wherein the at least one sidewall of each TIR optical component is a single angled sidewall such that the optical components have a frusto-conical configuration.

14. The lamp assembly of claim 8 wherein the engagement member of each TIR optical component is at least one tab and the complementary features are recesses for receiving the tabs.

15. The lamp assembly of claim 8 wherein the engagement member of each TIR optical component is at least one hooked catch and the complementary features are slots for receiving the catches, rotation of a TIR optical component securing it to the LED holder with the at least one hooked catch received in a slot.

16. The lamp assembly of claim 8 wherein the engagement member of each TIR optical component is at least one recess for receiving a tab and the complementary features are tabs.

17. The lamp assembly of claim 8 wherein the engagement member of each TIR is a rib projecting from the bottom surface and recessed from the sidewall and the complementary feature is a groove or a plurality of slots for receiving the rib.

18. The lamp assembly of claim 8 wherein the TIR optical components are elements of a single fixture.

19. A lens array comprising a plurality of the TIR optical components of claim 1, molded into a single fixture.
